(19) United States
(12) Patent Application Publication
(10) Pub. No.: US 2010/0130679 A1
(43) Pub. Date: May 27, 2010

(54) METHOD FOR PRODUCING AQUEOUS VINYL ESTER DISPERSIONS

(76) Inventors: Martin Jakob, Kelkheim (DE); Bernhard Momper, Weilberg (DE); Jan-Erik Jonnson, Lund (SE); Anders Hansson, Gislaved (SE)

Correspondence Address: DORITY & MANNING, P.A., POST OFFICE BOX 1449, GREENVILLE, SC, 29602-1449, US

(21) Appl. No.: 12/307,233

(22) PCT Filed: Jun. 5, 2007
(86) PCT No.: PCT/EP2007/004972

§ 371 Date: Feb. 8, 2010

(30) Foreign Application Priority Data
Jul. 3, 2006 (DE) 10 2006 030 557.4

(51) Int. Cl. C08F 2/22

(52) U.S. Cl. 524/803; 524/832

(57) ABSTRACT

The preparation of vinyl ester homo- or copolymers by emulsion polymerization is described. The process is performed in the presence of a polymerization-retarding component in at least two phases, the concentration of the vinyl ester monomer in the polymerization mixture in the first phase having been depleted by not more than 50% at the end of the first phase compared to the concentration of the vinyl ester monomer in the polymerization mixture at the start of the first phase, and the concentration of the vinyl ester monomer in the polymerization mixture in the second phase being depleted compared to the concentration at the end of the first phase. The retarding component is depleted during the first phase. In the second phase, the heat of reaction is removed by evaporative cooling. In the first phase, the emulsion polymerization is effected at temperatures up to the boiling point of the vinyl ester-water azeotrope, and, in the second phase, at temperatures above the boiling point of the vinyl ester-water azeotrope.

The process is notable for a short cycle time and high space-time yields and can be operated safely.

The present invention relates to an improved process for preparing aqueous vinyl ester dispersions, especially those based on vinyl ester copolymers.

Processes for free-radical polymerization have been known for some time.

In addition to polymerization in solution or in bulk, such reactions are frequently performed in emulsion. The polymerization processes should ensure high space-time yields and simultaneously maximum safety in the reaction regime. In addition, they should give rise to reaction products which are highly reproducible and which have a desired mean molecular weight and a desired molecular weight distribution. In free-radical emulsion polymerization, the process can be controlled via a multitude of process parameters. Examples thereof are polymerization temperature, metering rate of the reactants, removal of the heat of reaction, type and amount of constituents of the reaction system or construction of the polymerization reactor. There are accordingly numerous proposals in the literature for the performance of these polymerization reactions.

In Dechema Monographs, Vol. 137, p. 653-9 (2001), P. H. H. Araújo et al. described the influence of process parameters on the optimization of polymerization reactions of vinyl acetate emulsions. The article relates to the optimization of batch reactions of this monomer system. The process variables specified are temperature profiles and the addition rates of monomers and initiators, and reference is made to the influence of the heat removal capacity of the reactor. As a result of the optimization, significantly shortened cycle times can be achieved.

JP-A-07/082,304 describes the suspension polymerization of vinyl chloride in a reactor equipped with a reflux condenser. In order to shorten the polymerization time, a highly active and oil-soluble initiator is added to the reaction mixture before 60% of the overall conversion is attained.

DE 44 42 577 A1 describes a process for preparing emulsion polymers, in which hydrophobic monomers are used at least partly. The process is performed in stirred reactors with selection of a particular addition rate of the monomers. The polymerization is effected under reduced pressure, and a monomer/water mixture which distills off is condensed by cooling and recycled into the reaction mixture. In this process, a portion or the entire heat of reaction is removed by evaporative cooling.

WO 2005/016,977 A1 discloses a process for preparing aqueous polymer dispersions by free-radically initiated emulsion polymerization. This comprises the one-stage polymerization of at least one ethylenically unsaturated compound in the presence of at least one dispersant and of at least one water-soluble and of an oil-soluble free-radical initiator. The process begins at a starting reaction temperature which rises to an end reaction temperature in the course of the process. The one-stage process described permits the preparation of low-residual monomer aqueous polymer dispersions without the use of additional reducing agents.

EP 1 491 558 A1 describes a process for controlling the formation of a copolymer which derives from at least one relatively slow-reacting comonomer and a relatively fast-reacting comonomer. The process comprises the performance of tests to determine the reaction rates of the two monomers and the performance of the actual copolymerization, the addition of the faster-reacting monomers being controlled taking account of the data obtained by the test polymerization.

EP 0 486 262 A1 describes a process for preparing copolymer dispersions by controlled addition of the reactants. The reaction is controlled by adjusting the addition rate of the reactants and/or the polymerization temperature, the regulation being effected by observing the heat of reaction released and balancing it with the known energy balance of the reaction system.

WO 2004/096,871 A1 describes the improvement of a process for emulsion polymerization through use of a system of two initiators. The less stable initiator is metered in after the start of the polymerization at such a rate that the system has to be operated with maximum cooling capacity at the start of the reaction. The process permits high space-time yields without the reaction getting out of control.

WO 2004/113,392 A1 discloses a further process for free-radical polymerization, in which a peroxide which has a half-life of up to one hour at the polymerization temperature is used. The initiator is metered in at such a rate that the system has to be operated with maximum cooling capacity and the reaction temperature achieved is monitored, and kept at a predefined value through the addition rate of the initiator. The process permits preparation of polymers with highly reproducible K values. The process is described for the polymerization of vinyl chloride and optionally further comonomers.

WO 2005/000,916 A1 describes a process for aqueous emulsion polymerization, in which a combination of organic peroxide and a stabilizer is used for this purpose. At least a portion of the organic peroxide is added to the reaction mixture on attainment of the polymerization temperature. The process permits the preparation of polymers with relatively homogeneous molecular weight.

It is additionally known that vinyl ester homo- and copolymers can be prepared by free-radical emulsion polymerization in a batch process, in a feed process, in a combined batch/feed process or in a continuous process.

Typically, a combined batch/feed process or a feed process is employed. Usually, a small portion of the monomers, typically from 1 to 15% by weight, is initially charged at the start of polymerization. The monomers can be metered in either together or in separate feeds. In particular embodiments, for the establishment of specific particle sizes and particle size distributions, it may be advantageous to perform a seed polymerization. Feed processes allow relatively high process reliability on the industrial scale and can therefore usually be used without any problem in very large reactors. In unforeseen cases, stopping of the feeds allows critical reaction states to be avoided easily. Generally, the minimum metering time is limited by the cooling capacity of the available reactor jacket surface. Since products in the wood adhesives, paper adhesives and packaging adhesives sector generally also have relatively high viscosities, cooling efficiency is hindered. In the configuration of feed processes, the reaction mixture generally has a low steady-state monomer concentration which promotes chain transfer reactions. Owing to this, the achievable molecular weights are low. In addition, in these processes, protective colloids are hydrophobized by grafting and are removed from the aqueous phase. In general, both factors have an unfavorable effect on the performance properties for use as a paper or wood adhesive. Batch processes with a high monomer concentration at the start of the reaction lead to high molecular weights, low grafting rates, and lead to better products in terms of application. However, on the industrial scale, sometimes complicated precautions against the occurrence of runaway reactions have to be made. Polymerizations in large reactors are difficult to control in terms of safety.

Proceeding from this prior art, it was an object of the present invention to provide a process for emulsion polymerization of vinyl esters with high process reliability, which generates emulsion polymers with high molecular weights, similar to those of batch polymers, and additionally has enlarged space-time yields (=production throughput per unit volume and per unit time) as a result of reduced cycle times compared to conventional metering processes.

The process according to the invention has a number of alterations from the polymerization process employed to date. To date, the heat of reaction has been removed principally by jacket cooling in a conventional polymerization reactor for emulsion polymerization, and a relatively low monomer concentration in the reactor has been maintained during the polymerization process.

It has been found that, surprisingly, alterations of several process parameters give a process which can be performed much more economically and which can nevertheless be conducted safely.

The present invention provides a process for preparing an aqueous vinyl ester dispersion by free-radical emulsion polymerization, comprising the following measures:
i) initial charging or preparation of an aqueous emulsion comprising up to 30% of the total amount of the monomers to be polymerized, which contains a vinyl ester of a carboxylic acid and optionally further ethylenically unsaturated monomers copolymerizable therewith, and a portion or the total amount used in the process of at least one emulsifier and/or a portion or the total amount used in the process of at least one protective colloid, as a polymerization mixture in a reactor equipped with temperature control apparatus, preferably with a temperature-controllable jacket, and with a reflux condenser and stirring apparatus,
ii) using a compound which retards the polymerization and is added to the polymerization mixture before or after the start of polymerization,
iii) initiating the polymerization by adding a polymerization initiator for initiation and establishing a reactor temperature suitable for initiator decomposition,
iv) performing the polymerization reaction in a first phase, in which the reaction mixture has a temperature which corresponds to the boiling point of the azeotrope of the vinyl ester with water or lower, and in which the concentration of the vinyl ester monomer in the polymerization mixture has been depleted by not more than 50% at the end of the first phase compared to the concentration of the vinyl ester monomer in the polymerization mixture at the start of the first phase,
v) performing the polymerization reaction in a second phase which immediately follows the first phase, the reaction temperature being above the boiling point of the azeotrope of the vinyl ester with water and the concentration of vinyl ester monomer in the polymerization mixture in this phase being depleted compared to the concentration at the end point of the first phase, and the heat of polymerization being removed by means of evaporative cooling at reflux, or combined cooling being effected through removal of heat by means of temperature control apparatus, preferably by means of the temperature-controllable jacket, and evaporative cooling,
vi) metered addition of the residual monomer(s) beginning within the first phase of the polymerization or no later than at the start of the second phase, and ending with the end of the second phase,
vii) metered addition of a continuous or intermittent initiator feed during the polymerization, the feed being effected via both phases or in each case during one phase, preferably partially in the first phase and in the second phase, and
viii) depleting the retarding compound during the first phase.

In step i) of the process according to the invention, an aqueous emulsion comprising at least a portion of the monomer or of the monomers to be polymerized and at least a portion of the at least one emulsifier and/or of at least one protective colloid is initially charged. This polymerization mixture comprises a portion of the total amount of monomers to be polymerized. This polymerization mixture comprises a portion of the stabilization system, but it may also comprise the entire amount of emulsifier and/or of protective colloid. This latter embodiment is preferred.

Preference is given to initially charging, at the start of the polymerization, from 10 to 30% by weight of the total mass of monomers to be polymerized.

Preference is given to initially charging, at the start of the polymerization, the total mass of emulsifier and/or protective colloid. However, it is also possible for a portion of the total amount of the stabilization system sufficient for stabilization to be initially charged, and for the rest to be added continuously or in portions during the reaction. This can be done together with the feed of the monomers or separately therefrom.

The reactor is equipped with temperature control apparatus. This preferably comprises a temperature-controllable jacket. However, it may also comprise other industrial cooling apparatus, for example internal cooling coils or combinations of this cooling apparatus. In addition, the reactor is equipped with at least one reflux condenser. The reactor additionally also possesses a stirring apparatus which, as well as the required mixing of the reaction mixture, permits a reflux from the evaporative cooling to be emulsified within the reaction mixture, without significant amounts of monomer separating in the reactor during the reaction.

In step ii), a compound which retards the polymerization is used. This may already be present in the polymerization mixture, or it is added thereto before or after the start of polymerization. The nature of these compounds is explained in detail below.

A retarding compound is understood here to mean a compound according to the definition from Hans-Georg Elias: Makromoleküle [Macromolecules], Hüthig & Wepf Verlag Basle, 5th Edition, Volume 1, p. 481. A retarding compound or retardant, in contrast to true inhibitors, does not induce an induction period in which no conversion whatsoever takes place, and the polymerization instead sets in immediately but at a slower rate. This group of substances includes, for example, nitroaromatics, furans, vinylaromatics, allyl compounds and especially compounds which find use as comonomers in the polymerization of vinyl esters but form relatively unreactive free radicals after adding onto the macro radicals thereof and reduce the reaction rate. These include unsaturated dicarboxylic acids, for example maleic acid or fumaric acid, and their anhydrides, salts, partial salts, full esters or partial esters with C₁-C₁₂-alkanols or salts of these partial esters. Examples include dibutyl maleate, monobutyl maleate, maleic anhydride or maleic acid and salts thereof.

In process step iii), the polymerization is initiated by adding a polymerization initiator for initiation and establishing a reactor temperature suitable for initiator decomposition. For this purpose, it is possible to use either redox initiator systems or thermal systems. To establish a high molecular weight, however, systems which decompose purely thermally are preferred. The selection of the thermal initiator is guided by its half-life. These data are present in the relevant technical literature, such as in J. C. Masson in Polymer Handbook by J. Brandrup and E. H. Immergut, 3^{rd} Ed., p. II/1 to II/79, John Wiley & Sons, New York, or brochures or technical data sheets from the manufacturers. The decomposition of the initiator or of the initiator combination used must be sufficient at the selected reaction temperature, for which the upper limit is the boiling point of the azeotrope of the vinyl ester(s) with water, to initiate emulsion polymerization. In the case of polymerization of vinyl acetate as the vinyl ester and the position of the azeotrope of 66° C. at standard pressure, sufficient decomposition at the start of the first polymerization phase in the range between preferably 62° C. and 66° C. must be present. The initiators may be either water-soluble or oil-soluble (monomer-soluble). Suitable water-soluble compounds are salts of peroxodisulfuric acid, such as ammonium or sodium peroxodisulfate. It is also possible to use oil-soluble initiators or mixtures of the aforementioned systems. In a preferred embodiment of the invention, a mixture of water- and oil-soluble initiators is used.

The water-soluble free-radical initiators used may, for example, be peroxides or else azo compounds. The peroxides used may in principle be inorganic peroxides such as hydrogen peroxide, or peroxodisulfates such as the mono- or dialkali metal or mono- or diammonium salts of peroxo-disulfuric acid, for example the mono- and disodium, -potassium or -ammonium salts, or organic hydroperoxides, such as alkyl hydroperoxides, for example t-butyl, p-menthyl or cumyl hydroperoxide. The azo compounds used are, for example, 2,2′-azobis(amidinopropyl) dihydro-chloride (AIBA, corresponding to V-50 from Wako Chemicals).

Preference is given to using, as water-soluble free-radical initiators, a mono- or di-alkali metal or mono- or diammonium salt of peroxodisulfuric acid, for example dipotassium peroxodisulfate, disodium peroxodisulfate or diammonium peroxodisulfate. It will be appreciated that it is also possible to use mixtures of the aforementioned water-soluble free-radical initiators.

Examples of oil-soluble free-radical initiators include dialkyl and diaryl peroxides, such as di-tert-amyl peroxide, dicumyl peroxide, bis(tert-butyl-peroxyisopropyl)benzene, 2,5-bis(tert-butylperoxy)-2,5-dimethylhexane, tert-butylcumene peroxide, 2,5-bis(tert-butylperoxy)-2,5-dimethyl-3-hexene, 1,1-bis(tert-butylperoxy)-3,3,5-trimethylcyclohexane, 1,1-bis(tert-butyl-peroxy)cyclohexane, 2,2-bis(tert-butyl peroxy)butane or di-tert-butyl peroxide, aliphatic and aromatic peroxy esters such as cumyl peroxy-neodecanoate, 2,4,4-trimethyl-2-pentyl peroxyneodecanoate, tert-amyl peroxyneodecanoate, tert-butyl peroxyneodecanoate, tert-amyl peroxy-pivalate, tert-butyl peroxypivalate, tert-amyl peroxy-2-ethyl hexanoate, tert-butyl peroxy-2-ethylhexanoate, tert-butyl peroxydiethylacetate, 1,4-bis(tert-butylperoxy)cyclohexane, tert-butyl peroxyisobutanoate, tert-butyl peroxy-3,5,5-trimethylhexanoate, tert-butyl peroxyacetate, tert-amyl peroxybenzoate or tert-butyl peroxybenzoate, dialkanoyl and dibenzoyl peroxides, such as diisobutanoyl peroxide, bis(3,5,5-trimethylhexanoyl) peroxide, dilauroyl peroxide, didecanoyl peroxide, 2,5-bis(2-ethylhexanoylperoxy)-2,5-dimethylhexane or dibenzoyl peroxide, and peroxycarbonates such as bis(4-tert-butylcyclohexyl) peroxydicarbonate, bis(2-ethylhexyl) peroxydicarbonate, di-tert-butyl peroxydicarbonate, diacetyl peroxydicarbonate, dimyristyl peroxydicarbonate, tert-butyl peroxyisopropylcarbonate or tert-butyl peroxy-2-ethylhexyl carbonate, and oil-soluble azo compounds such as 2,2′-azobis(isobutyronitrile).

The polymerization initiators used may also be so-called redox initiators which are composed of at least one organic and/or inorganic reducing agent and at least one peroxide and/or hydroperoxide, for example tert-butyl hydroperoxide with sulfur compounds, for example the sodium salt of hydroxymethanesulfinic acid, sodium sulfite, sodium disulfite, sodium thiosulfate and acetone bisulfite adduct, or hydrogen peroxide with ascorbic acid. It is also possible to use combined systems which comprise a small amount of a metal compound soluble in the polymerization medium, whose metallic component can occur in several valency states, for example ascorbic acid/iron sulfate/hydrogen peroxide, in which it is frequently also possible to use, instead of ascorbic acid, the sodium salt of hydroxymethanesulfinic acid, acetone bisulfite adduct, sodium sulfite, sodium hydrogensulfite or sodium bisulfite, and, instead of hydrogen peroxide, organic peroxides, for example tert-butyl hydroperoxide, or alkali metal peroxodisulfates and/or ammonium peroxodisulfate.

Redox initiators are less preferably used.

The total amount of free-radical initiator used is from 0.01 to 5% by weight, preferably from 0.05 to 3% by weight and more preferably from 0.05 to 2% by weight, based in each case on the total amount of monomers.

Before the start of the polymerization, the reactor temperature is increased, for example by increasing the jacket temperature, such that the polymerization mixture present in the reactor is heated to its boiling point or to a temperature below it, preferably a temperature lower by up to 10° C., especially by up to 5° C. Once the reactor contents have attained this temperature, the polymerization initiator is added and the polymerization is initiated. The initiator used for initiation or the initiator mixture may, though, also already be present in the reaction mixture, i.e. have been added, for example, in step i). The sequence of addition is not critical for the process according to the invention.

After the reaction starts up, the actual polymerization reaction is carried out. This can be divided into at least two phases. In a first phase (step iv), the reaction mixture has a temperature which corresponds to the boiling point of the azeotrope of the vinyl ester at the prevailing external pressure with water or lower. During this first phase, the depletion of the vinyl ester monomer in the polymerization mixture is prevented by the action of the retarding component. The reaction should be conducted such that the concentration of the vinyl ester monomer at the end of the first phase has been depleted by not more than 50% compared to the concentration of the vinyl ester monomer at the start of the first phase. In the course of this first phase, the concentration of the vinyl ester monomer in the polymerization mixture is typically at least 5% by weight, preferably ≧7.5% by weight and more preferably ≧9% by weight, based on the polymerization mixture. In the course of the first phase, the concentration of the vinyl ester monomer in the polymerization mixture varies typically within the range from 5 to 40% by weight, especially in the range from 7.5 to 35% by weight and most preferably in the range from 9 to 30% by weight, based on the polymerization mixture. The reaction conditions and if appropriate the addition of vinyl ester monomers should thus be selected such that a comparatively high proportion of unreacted vinyl ester monomer is always present in the polymerization mixture within this phase.

The reaction temperature is effected appropriately by adjusting the jacket temperature. It has been found to be appropriate to predefine an internal temperature as the target value by closed-loop control within this phase, and to regulate the external temperature by means of the automatic system.

In the case of use of vinyl acetate as the vinyl ester, an azeotrope thus forms with water, which boils at 66° C. under standard pressure. In the case of vinyl acetate as the monomer, the reaction is performed at or below this temperature in this first phase of the polymerization, for example in the range from 56 to 66° C., preferably in the range from 59 to 66° C., especially in the range from 62 to 66° C. These temperature data are based on the performance of the polymerization at standard pressure.

The heat of reaction formed in the polymerization is removed in this first phase by means of gentle evaporative cooling when working at the azeotrope boiling point; the heat is removed, for example, via the reactor jacket when working below the boiling point.

The presence of the retarding compound prevents premature depletion of the vinyl ester monomer in the first phase and prevents a premature temperature rise. The reaction conditions thus established make a crucial contribution to the formation of a high molecular weight by virtue of linear polymerization.

Within this phase of the polymerization, the retarding compound is gradually depleted by consumption and polymerization, which has the consequence that the reaction rate increases later in the reaction.

In the next phase of the polymerization reaction (step v), the reaction temperature is above the boiling point of the vinyl ester/water azeotrope and the heat of reaction which is released more rapidly as a result of acceleration of the reaction is removed by evaporative cooling at reflux or combined cooling by removal of heat, for example through the jacket and/or other cooling apparatus and evaporative cooling. At the start of this phase, the reaction mixture still has a high concentration of free vinyl ester. The concentration of vinyl ester monomer in the polymerization mixture of the second phase is depleted compared to the concentration of this monomer at the end point of the first phase. The concentration becomes increasingly small and the monomer concentration is finally no longer sufficient to form an azeotrope. In this phase, the internal temperature increases continuously. Control within this phase can be effected by establishing a minimum fixed jacket temperature, which is in practice limited by the available cooling water temperature.

The heat of reaction which arises in the polymerization is removed within this phase by significant evaporative cooling. In contrast to the prior art processes, in which the heat of reaction is removed by jacket cooling, in the process according to the invention the water of the polymerization mixture is partially evaporated, condensed in the reflux condenser and recycled into the polymerization vessel. Owing to the high heat of evaporation of the monomer, this type of cooling is very efficient. However, the failure of the reflux condenser may constitute a certain risk. This can be countered by appropriate dimensions of the cooling capacity of the jacket.

At the end of the second phase, the feed of the monomer(s) is stopped and the concentration of vinyl ester monomers in the polymerization mixture at this time is below 10% by weight, preferably below 5% by weight, based on the polymerization mixture.

The reaction temperature over the entire process is generally at variable temperatures in the range from 40 to 120° C., preferably in the range from 50 to 100° C. and more preferably in the range from 55 to 95° C.

The remaining monomeric vinyl ester (step vi) is preferably metered in during both polymerization phases. It has been found to be advantageous to start the feed within the first polymerization phase, which counteracts excessively early depletion of the monomer in the mixture in the first phase. However, it is also possible to start the feed at the start of the second phase when the internal temperature rises. The metered addition can be effected in a linear manner or in stepwise or continuous profiles at different metering rates. In a specific embodiment of the process, it has been found to be favorable in practice to select a relatively low rate of addition at the start and then to increase it continuously, the monomer introduction being at its highest when the reaction rate is also high.

During the reaction, preference is also given to supplying further initiator and if appropriate emulsifier and/or protective colloid. This supply is effected over both phases or in each case during one phase, preferably partially in the first phase and in the second phase. Preference is given to undertaking the feeding of the initiator in parallel with the monomer feed. Here too, the metered addition can be effected in a linear manner or in stepwise or continuous profiles with different metering rates. The type of initiator used is preferably the same as that used to initiate the polymerization. However, it is also possible to use other initiators with different half-lives, for example those with shorter or longer half-lives or different solubilities.

The solids content of the polymer dispersion prepared in accordance with the invention is typically in the range from 20 to 80% by weight, preferably in the range from 40 to 70% by weight and especially in the range from 45 to 60% by weight. In this description, the term “solids content” is understood to mean the total mass of polymer based on the total mass of the dispersion.

The size of the polymer particles in the dispersion prepared in accordance with the invention may vary within wide ranges. Typical particle diameters vary within the range from 0.05 to 5 μm, preferably from 0.1 to 2 μm.

The polymer dispersions prepared in accordance with the invention typically have a pH which is in the range from 2 to 9 and more preferably in the range from 3 to 7.

The polymer dispersions prepared in accordance with the invention are vinyl ester homopolymers or vinyl ester copolymers.

The vinyl esters used in accordance with the invention derive from carboxylic acids having from 1 to 18 carbon atoms. It is possible to use all monomers known to those skilled in the art.

Preference is given to vinyl esters of carboxylic acids having from 1 to 8 carbon atoms, for example vinyl formate, vinyl acetate, vinyl propionate, vinyl isobutyrate, vinyl pivalate and vinyl 2-ethylhexanoate; vinyl esters of saturated, branched monocarboxylic acids having 9, 10 or 11 carbon atoms in the acyl radical (®Versatic acids); vinyl esters of relatively long-chain saturated and unsaturated fatty acids, for example vinyl laurate and vinyl stearate; vinyl esters of benzoic acid or of p-tert-butylbenzoic acid, and mixtures thereof.

Particular preference is given to vinyl esters of carboxylic acids having from 1 to 4 carbon atoms, mixtures of vinyl acetate and at least one Versatic acid, and mixtures of vinyl acetate and vinyl laurate. Vinyl acetate is especially preferred.

Examples of monomers copolymerizable with vinyl esters are monoethylenically unsaturated, optionally halogen-substituted hydrocarbons which preferably have from two to four carbon atoms. Examples thereof are ethene, propene, 1-butene, 2-butene, isobutene, vinyl chloride and vinylidene chloride, preference being given to ethene and mixtures of ethene and vinyl chloride. The proportion of these monomers in the vinyl ester copolymer is, based on the total mass of the monomers used to prepare the vinyl ester copolymer, preferably less than 20% by weight.

Preferred monomer mixtures from the abovementioned monomers are vinyl acetate/vinyl chloride/ethene, vinyl acetate/vinyl laurate/ethene, vinyl acetate/vinyl laurate/ethene/vinyl chloride, vinyl acetate/vinyl versatate/ethene/vinyl chloride, vinyl versatate/ethene/vinyl chloride, vinyl acetate/vinyl versatate/ethene and vinyl acetate/ethene, particular preference being given to the vinyl acetate/ethene combination.

Further monomers copolymerizable with vinyl esters are ethylenically unsaturated, ionic monomers, for example compounds which bear at least one carboxylic acid, sulfonic acid, phosphoric acid or phosphonic acid group directly adjacent to the double bond unit, or else are bonded thereto via a spacer. Examples include:

α,β-unsaturated C₃-C₈-monocarboxylic acids, α,β-unsaturated C₅-C₈-dicarboxylic acids and anhydrides thereof, and monoesters of α,β-unsaturated C₄-C₈-dicarboxylic acids.

Preference is given to unsaturated monocarboxylic acids, for example acrylic acid and methacrylic acid and the anhydrides thereof; unsaturated dicarboxylic acids, for example maleic acid, fumaric acid, itaconic acid and citraconic acid and the monoesters thereof with C₁-C₁₂-alkanols such as monomethyl maleate and mono-n-butyl maleate. Further preferred ethylenically unsaturated ionic monomers are ethylenically unsaturated sulfonic acids, for example vinylsulfonic acid, 2-acrylamido-2-methyl-propanesulfonic acid, 2-acryloyloxy- and 2-methacryloyloxyethanesulfonic acid, 3-acryloyloxy- and 3-methacryloyloxypropanesulfonic acid and vinyl-benzenesulfonic acid, and ethylenically unsaturated phosphonic acids, for example vinylphosphonic acid.

In addition, as well as the acids mentioned, it is also possible to use the salts thereof, preferably the alkali metal salts thereof or the ammonium salts thereof and especially the sodium salts thereof, for example the sodium salts of vinylsulfonic acid and of 2-acrylamidopropanesulfonic acid.

The ethylenically unsaturated free acids mentioned are present in aqueous solution at pH 11 predominantly in the form of their conjugate bases in anionic form and can, like the salts mentioned, be referred to as anionic monomers.

Additionally suitable as ethylenically unsaturated ionic monomers are also monomers with cationic functionality, for example monomers based on quaternary ammonium groups. However, preference is given to anionic monomers.

Still further monomers copolymerizable with vinyl esters are ethylenically unsaturated, copolymerizable organosilicon compounds.

Examples thereof are monomers of the general formula RSi(CH₃)₀₋₂(OR¹)₃₋₁ where R is defined as CH₂═CR²—(CH₂)₀₋₁ or CH₂═CR²—CO₂—(CH₂)₁₋₃, R¹ is an unbranched or branched, optionally substituted alkyl radical which has from 3 to 12 carbon atoms and may optionally be interrupted by an ether group, and R² is H or CH₃.

Still further monomers copolymerizable with vinyl esters are ethylenically unsaturated, nonionic monomers. Among these are both the amides of the carboxylic acids mentioned in connection with the ethylenically unsaturated, ionic monomers, for example (meth)acrylamide and acrylamide, and water-soluble N-vinyllactams, for example N-vinylpyrrolidone, and those compounds which contain covalently bonded polyethylene glycol units as ethylenically unsaturated compounds, for example polyethylene glycol monoallyl or diallyl ether, or the esters of ethylenically unsaturated carboxylic acids with polyalkylene glycols.

Still further monomers copolymerizable with vinyl esters are esters of ethylenically unsaturated C₃-C₈-mono- and dicarboxylic acids with C₁-C₁₈, preferably C₁-C₁₂ and more preferably C₁-C₈ alkanols or C₅-C₈ cycloalkanols. Particular preference is given to the esters of acrylic acid, of methacrylic acid, of crotonic acid, of maleic acid, of itaconic acid, of citraconic acid and of fumaric acid. Especially preferred are the esters of acrylic acid and/or of (meth)acrylic acid, for example methyl (meth)acrylate, ethyl (meth)acrylate, isopropyl (meth)acrylate, n-butyl (meth)acrylate, isobutyl (meth)acrylate, 1-hexyl (meth)acrylate, tert-butyl (meth)acrylate, 2-ethylhexyl (meth)acrylate, and the esters of fumaric acid and of maleic acid, for example dimethyl fumarate, dimethyl maleate, di-n-butyl maleate, di-n-octyl maleate and di-2-ethylhexyl maleate. The esters mentioned may optionally also be substituted by epoxy and/or hydroxyl groups. Also useful as further ethylenically unsaturated monomers are nitriles of α,β-mono-ethylenically unsaturated C₃-C₈-carboxylic acids, for example acrylonitrile and methacrylonitrile. It is also possible to use C₄-C₈ conjugated dienes, for example 1,3-butadiene, isoprene and chloroprene, as further ethylenically unsaturated monomers.

In addition, the further ethylenically unsaturated monomers used may be those compounds which are known to improve adhesion properties and/or act as crosslinkers. The adhesion-improving monomers include both compounds which have an acetoacetoxy unit bonded covalently to the double bond system and compounds with covalently bonded urea groups. The former compounds include especially acetoacetoxyethyl (meth)acrylate and allyl acetoacetate. The urea group-containing compounds include, for example, N-vinyl- and N-allylurea, and derivatives of imidazolidin-2-one, for example N-vinyl- and N-allylimidazolidin-2-one, N-vinyloxyethylimidazolidin-2-one, N-(2-(meth)acrylamidoethyl)imidazolidin-2-one, N-(2-(meth)acryloyl-oxyethyl)imidazolidin-2-one and N-(2-(meth)acryloyloxyacetamido-ethyl)imidazolidin-2-one, and further adhesion promoters which are based on urea or imidazolidin-2-one and are known to those skilled in the art. Also suitable for improving adhesion is diacetoneacrylamide in combination with a subsequent addition of adipic dihydrazide to the dispersion. The adhesion-promoting monomers may optionally be used in amounts of from 0.1 to 10% by weight, preferably from 0.5 to 5% by weight, based on the total mass of the monomers used in the particular monomer mixture.

The crosslinking monomers used may be either bifunctional or polyfunctional monomers. Examples thereof are diallyl phthalate, diallyl maleate, triallyl cyanurate, tetraallyloxyethane, divinylbenzene, butanediol 1,4-di(meth)acrylate, triethylene glycol di(meth)acrylate, divinyl adipate, allyl (meth)acrylate, vinyl crotonate, methylenebisacrylamide, hexanediol diacrylate, pentaerythritol diacrylate and trimethylolpropane triacrylate. The crosslinking monomers may optionally be used in amounts of from 0.02 to 5% by weight, preferably from 0.02 to 1% by weight, based on the total mass of the monomers used in the particular monomer mixture.

In a particularly preferred embodiment of the process according to the invention, vinyl esters and anhydrides of ethylenically unsaturated carboxylic acids and ethylenically unsaturated carboxylic acids or salts thereof are used as monomers. These anhydrides act as retarding compounds in the emulsion polymerization; this allows the generation of heat of reaction to be controlled. A very preferred monomer of this type is maleic anhydride or free maleic acid or the partial salts or full salts thereof.

In the process according to the invention, it is possible to use emulsifiers and/or protective colloids.

The total mass of emulsifiers, based on the total mass of monomers used, is from 0.01 to 5% by weight, preferably from 0.1 to 4% by weight, more preferably from 0.5 to 2% by weight.

It is possible to use ionic and nonionic emulsifiers.

The ionic emulsifiers include both anionic and cationic emulsifiers, particular preference being given to anionic emulsifiers and mixtures of anionic emulsifiers.

The anionic emulsifiers include alkali metal and ammonium salts of alkyl sulfates (alkyl radical: C₆ to C₁₈), alkyl phosphonates (alkyl radical: C₆ to C₁₈), of sulfuric monoesters or phosphoric mono- and diesters of ethoxylated alkanols (EO: 2 to 50, alkyl radical: C₆ to C₂₂) and ethoxylated alkylphenols (EO: 3 to 50, alkyl radical: C₄ to C₉), of alkylsulfonic acids (alkyl radical: C₁₂ to C₁₈), of alkylarylsulfonic acids (alkyl radical: C₉ to C₁₈), of sulfosuccinic monoesters and sulfosuccinic diesters of alkanols (alkyl radical C₆ to C₂₂) and ethoxylated alkanols (EO: 2 to 50, alkyl radical: C₆ to C₂₂), and nonethoxylated and ethoxylated alkylphenols (EO: 3 to 50, alkyl radical: C₄ to C₉).

In general, the emulsifiers listed are used in the form of technical mixtures, where the figures for length of alkyl radical and EO chain are based on the particular maximum of the distributions occurring in the mixtures. Examples from the emulsifier classes mentioned are ®Texapon K12 (sodium lauryl-sulfate from Cognis), ®Emulsogen EP (C₁₃-C₁₇ alkylsulfonate from Clariant), ®Maranil A 25 IS (sodium n-(C₁₀-C₁₃)-alkylbenzenesulfonate from Cognis), ®Genapol liquid ZRO (sodium C₁₂/C₁₄-alkyl ether sulfate with 3 EO units from Clariant), ®Hostapal BVQ-4 (sodium salt of a nonylphenol ether sulfate with 4 EO units from Clariant), ®Aerosol MA 80 (sodium dihexyl-sulfosuccinate from Cytec Industries), ®Aerosol A-268 (disodium iso-decylsulfosuccinate from Cytec Industries), ®Aerosol A-103 (disodium salt of a monoester of sulfosuccinic acid with an ethoxylated nonylphenol from Cytec Industries).

Additionally suitable are compounds of the general formula 1

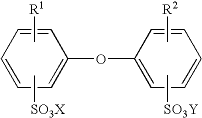

in which R¹ and R² are each hydrogen or C₄-C₂₄-alkyl, preferably C₆-C₁₆-alkyl, and are not both hydrogen, and X and Y are each alkali metal ions and/or ammonium ions. Frequently, in the case of these emulsifiers too, technical mixtures are used, which have a proportion of from 50 to 90% by weight of the monoalkylated product, for example Dowfax® 2A1 (R¹═C₁₋₂-alkyl; Dow Chemical). The compounds are common knowledge, for example from U.S. Pat. No. 4,269,749, and are commercially available.

Additionally suitable as ionic emulsifiers are also the Gemini surfactants known to those skilled in the art, as described, for example, in the article “Gemini-Tenside” [Gemini surfactant] by F. M. Menger and J. S. Keiper (Angew. Chem. 2000, p. 1980-1996) and the publications cited therein.

The cationic emulsifiers include, for example, alkyl ammonium acetates (alkyl radical: C₈ to C₁₂), quaternary compounds containing ammonium groups, and pyridinium compounds.

In the selection of the ionic emulsifiers, it should of course be ensured that incompatibilities in the resulting polymer dispersion, which may lead to coagulation, can be ruled out. Preference is therefore given to using anionic emulsifiers in combination with anionic monomers (M3) or cationic emulsifiers in combination with cationic monomers (M3), particular preference being given to the combinations of anionic emulsifiers and anionic monomers.

Suitable nonionic emulsifiers are araliphatic and aliphatic nonionic emulsifiers, for example ethoxylated mono-, di- and trialkylphenols (EO: 3 to 50, alkyl radical: C₄ to C₉), ethoxylates of long-chain branched or unbranched alcohols (EO: 3 to 50, alkyl radical: C₆ to C₃₆), aryl-substituted phenol alkyleneoxy ethers, and polyethylene oxide/polypropylene oxide block copolymers.

Preference is given to using ethoxylates of long-chain branched or unbranched alkanols (alkyl radical: C₆ to C₂₂, mean degree of ethoxylation: 3 to 50), and among these particular preference to those based on native alcohols, Guerbet alcohols or oxoalcohols with a linear or branched C₁₂-C₁₈-alkyl radical and a degree of ethoxylation 10 of from 8 to 50.

Further suitable emulsifiers can be found in Houben-Weyl, Methoden der organischen Chemie [Methods of Organic Chemistry], Volume XIV/I, Makromolekulare Stoffe [Macromolecular Substances], Georg-Thieme-Verlag, Stuttgart, 1961, p. 192-208).

In addition, it is possible to use both ionic and nonionic emulsifiers which, as an additional functionality, contain one or more unsaturated double bond units and can be incorporated into the polymer chain as it forms during the polymerization process as ethylenically unsaturated, ionic monomers or as ethylenically unsaturated, nonionic monomers. These compounds referred to as copolymerizable emulsifiers (“surfmers”) are common knowledge to those skilled in the art. Examples can be found in a number of publications (e.g.: “Reactive surfactants in heterophase polymerization” by A. Guyot et al. in Acta Polym. 1999, p. 57-66) and are commercially available (e.g. ®Emulsogen R 208 from Clariant or Trem LF 40 from Cognis).

In addition to or instead of ionic stabilizing components, protective colloids are used in the process according to the invention.

These are understood to mean polyvinyl alcohols, starch and cellulose derivatives, and polyvinylpyrrolidone.

Particular preference is given to using polyvinyl alcohols.

In a preferred embodiment of the process according to the invention, the emulsion polymerization is effected in the presence of protective colloids, for example of polyvinyl alcohols, starch and cellulose derivatives, and polyvinylpyrrolidone, preference being given to polyvinyl alcohols and cellulose derivatives, for example hydroxyethylcelluloses.

A detailed description of further suitable protective colloids can be found in Houben-Weyl, Methoden der organischen Chemie, Volume XIV/I, Makromolekulare Stoffe, Georg Thieme Verlag, Stuttgart 1961, p. 411 to 420.

The molecular weight of the vinyl ester copolymers can be adjusted by adding small amounts of one or more substances which regulate the molecular weight. These so-called “regulators” are generally used in an amount of up to 2% by weight based on the monomers to be polymerized. The “regulators” used may be all substances known to those skilled in the art.

Preferred examples are organic thio compounds, silanes, allyl alcohols and aldehydes.

However, preference is given in the process according to the invention to not using any regulators.

In addition to the seed-free preparation method, a defined polymer particle size can also be established by conducting the emulsion polymerization by the seed latex process or in the presence of seed latices prepared in situ. Such processes are known and are described in detail in a multitude of patent applications, (e.g. EP-A-0 040 419 and EP-A-0 567 812) and publications (“Encyclopedia of Polymer Science and Technology”, Vol. 5, John Wiley & Sons Inc., New York 1966, p. 847).

After the actual polymerization reaction, it may be desirable and/or necessary to configure the inventive aqueous polymer dispersions such that they are substantially free of odor carriers, for example residual monomers and other volatile organic constituents. This can be achieved in a manner known per se, for example physically by distillative removal (especially by means of steam distillation) or by stripping with an inert gas. In addition, the residual monomers can also be lowered chemically by free-radical postpolymerization, especially by the action of redox initiator systems, as described, for example, in DE-A-44 35 423. Preference is given to postpolymerization with a redox initiator system composed of at least one organic peroxide and an organic and/or inorganic sulfite. Particular preference is given to a combination of physical and chemical methods, lowering of the residual monomer content by chemical post-polymerization typically being followed by the further lowering of the residual monomer content by means of physical methods to preferably <1000 ppm, more preferably <500 ppm, especially <100.

The aqueous polymer dispersions which are based on vinyl ester homo- or copolymers and are prepared in accordance with the invention are preferably used in the adhesives sector as a paper, packing or wood adhesive, but, for example, also as a binder in pigment-containing aqueous formulations which serve to coat substrates. Examples of these include synthetic resin-bound plasters, tile adhesives, paints, for example emulsion paints, dispersion coating materials and glazes, sealants and sealing compounds, preferably for porous components, but also papercoating slips.

The inventive polymerization process affords high-value products in performance terms, which can be produced in a process with high process reliability and extremely short cycle time, and/or high space-time yield.

The aqueous polymer dispersions can also be used, directly or after addition of rheology-modifying additives and/or further components, as aqueous formulations for adhesive bonding and coating of substrates. Such aqueous formulations are, for example, primers, clearcoats or else food coatings which protect foods, for example cheese or meat-containing preparations, from harmful environmental influences and/or drying out.

The invention is described in detail below with reference to working examples, without being restricted in any way as a result.

### EXAMPLE 1

To perform the experiment, a pilot plant reactor of capacity 120 l was used, which was equipped with a reflux condenser, metering pumps and reservoirs and with electrical control apparatus, a reactor jacket equipped with a pneumatically operated steam/water control circuit, and a close-clearance anchor stirrer provided with several cross-beams (90 rpm). It was charged with a solution of 3.36 kg of polyvinyl alcohol of degree of hydrolysis 88 mol % and with a viscosity of the 4% aqueous solution at 20° C. of 23 mPa*s in 31.6 kg of deionized water. 17.5 g of sodium acetate as a buffer and 33.6 g of Agitan 282 as a defoamer were added to the solution. A solution of 105 g of maleic anhydride in 105 g of deionized water was added to the mixture, as were 17.5 g of dibenzoyl peroxide as an oil-soluble initiator. 7 kg of vinyl acetate (20% of the total amount) were emulsified in with stirring and the internal temperature was raised. At 55° C., a solution of 8.8 g of ammonium peroxodisulfate in 89 g of deionized water was added to start the reaction. Closed-loop control was used to set the internal temperature to target value 64° C., and the startup of the reaction (start of phase 1) was controlled by the regulation of the jacket temperature which was caused by the exothermicity which occurred. Once the jacket temperature was below the internal temperature, 28 kg of vinyl acetate and a feed of 4.4 g of ammonium peroxodisulfate in 1 kg of deionized water were metered in in a linear manner over 120 min. After metered addition of approx. 45% of the monomer, the exothermicity became more intense and phase 2 began. The heat of polymerization was then removed under reflux and the internal temperature rose slowly. The jacket temperature was switched from closed-loop control to manual control and lowered gradually to 50° C. toward the end of metered addition.

At the end of the feed, the internal temperature was 72° C. and then rose to 90° C. within another 30 min. Polymerization was continued for another hour at jacket temperature 80° C. and the mixture was demonomerized with additions of sodium metabisulfite and tert-butyl hydroperoxide.

A coagulate-free dispersion with the following properties was obtained:

Viscosity (Brookfield RVT, sp. 6/20 23° C.): 28 700 mPa*s
Solids content: 52.3%
Screen residue (180 μfabric): 0.007%
Residual vinyl acetate: 300 ppm
Mean particle size (mass-average, determined by Malvern Mastersizer): 0.59 μm.

### COMPARATIVE EXAMPLE 1

Product of identical composition prepared in a pure batchwise process (100% vinyl acetate initially charged, polymerization additionally retarded with nitro compound).

### K Value Determination

The K value is a relative viscosity number which is determined in analogy to DIN 53726. The determination is a relative method for determining the molecular weight of a polymer. The solvent used was dimethyl sulfoxide. 2 g of the dispersion diluted to 50% (i.e. 1 g of polymer) was weighed accurately into a 100 ml standard flask with an analytical balance. Subsequently, the mixture was made up to 100 ml with DMSO and the polymer was dissolved. The comparative solvent used was a solution of 1 g of water per 100 g of DMSO solution. The relative viscosity as a basis for the calculations was determined by means of an Ostwald viscometer. The analysis temperature was 20° C.

TABLE 1

| Product | K value |
|---|---|
| Example 1 | 110 |
| Comparative Example 1 (batch) | 112 |
| Typical values for metered addition methods | 40-90 |

These values show clearly that molecular weights comparable to those of batch methods are obtained by the process according to the invention.

### EXAMPLE 2

### Determination of Monomer Concentrations During the Start Phase of the Polymerization

Example 1 was repeated and samples were taken from the mixture in the course of the reaction by means of a sampler, and were immediately admixed with inhibitor for the purpose of preventing continued polymerization. The samples were diluted and the concentration of vinyl acetate was determined by head space gas chromatography. The values illustrate the controlled accumulation of monomers in the first half of the polymerization. These values are sufficient to achieve high molecular weights, but are insufficient in any phase to exceed critical design pressures of commercial polymerization reactors after a runaway reaction.

TABLE 2

| | Vinyl |
|---|---|
| Polymerization phase | acetate concentration (%) |
| Start of reaction (Phase 1) | 17 |
| Start of metered addition (Phase 1) | 10 |
| After 25% of feed (Phase 1) | 19 |
| After 50% of feed (start of Phase 2) | 19 |

### EXAMPLE 3

2 parts by weight of butyl diglycol acetate were added as a film-forming assistant to 100 parts by weight of the dispersion from example 1, and in this way a ready-to-use wood adhesive was obtained. The solids content was 53.3%, the viscosity 33 600 mPas by Brookfield RVT. The minimum film formation temperature was 3° C.

### COMPARATIVE EXAMPLE 2

Mowilith® DLR, commercial product from Celanese Emulsions GmbH, a wood adhesive which comprises film formation assistant, is produced in a conventional metered addition process, and has a minimum film formation temperature of 2° C., a viscosity of 15 550 mPa*s and a solids content of 49.7%.

Testing of the thermal stability of the wood adhesives (wood adhesive temperature test, WATT 91). The WATT 91 indicates the shear strength at break at 80° C. in N/mm² as a measure of the thermal stability of an adhesive.

The specimens were produced according to the procedure of DIN EN 205. The gluing and testing were carried out taking account of the following parameters:

| | |
|---|---|
| Glue application: | 150 ± 20 g/m² applied on both sides |
| Open wait time: | 3 minutes |
| Closed wait time: | 3 minutes |
| Pressing time: | 2 hours |
| Pressure: | 0.7 ± 0.1 N/mm² |
| Number of specimens per test | 20 |
| series: | |
| Testing after | 7 days of standard climatic conditions*⁾ |
| Storage: | 80° C. in heating cabinet for 1 h |
| Testing temperature: | 23° C. ± 2° C. |
| Advance rate: | 50 mm/min |

*⁾23 ± 2° C. and 50 ± 5% relative air humidity

TABLE 3

| Sample | WATT 91/N/mm² |
|---|---|
| Example 3 | 6.5 |
| Comparative Example 2 | 4.0 |

These values show clearly the effect of the molecular weight, which imparts a higher thermal stability of the adhesive film to the product produced in the process according to the invention.

1. A process for preparing an aqueous vinyl ester dispersion by free-radical emulsion polymerization, comprising the following measures:
i) initial charging or preparation of an aqueous emulsion comprising up to 30% of the total amount of the monomers to be polymerized, which contains a vinyl ester of a carboxylic acid and optionally further ethylenically unsaturated monomers copolymerizable therewith, and a portion or the total amount used in the process of at least one emulsifier and/or a portion or the total amount used in the process of at least one protective colloid, as a polymerization mixture in a reactor equipped with temperature control apparatus and with a reflux condenser and stirring apparatus,
ii) using a compound which retards the polymerization and is added to the polymerization mixture before or after the start of polymerization,
iii) initiating the polymerization by adding a polymerization initiator for initiation and establishing a reactor temperature suitable for initiator decomposition,
iv) performing the polymerization reaction in a first phase, in which the reaction mixture has a temperature which corresponds to the boiling point of the azeotrope of the vinyl ester with water or lower, and in which the concentration of the vinyl ester monomer in the polymerization mixture has been depleted by not more than 50% at the end of the first phase compared to the concentration of the vinyl ester monomer in the polymerization mixture at the start of the first phase,
v) performing the polymerization reaction in a second phase which immediately follows the first phase, the reaction temperature being above the boiling point of the azeotrope of the vinyl ester with water and the concentration of vinyl ester monomer in the polymerization mixture in this phase being depleted compared to the concentration at the end point of the first phase, and the heat of polymerization being removed by means of evaporative cooling at reflux, or combined cooling being effected through removal of heat by means of temperature control apparatus and evaporative cooling,
vi) metered addition of the residual monomer(s) beginning within the first phase of the polymerization or no later than at the start of the second phase, and ending with the end of the second phase,
vii) metered addition of a continuous or intermittent initiator feed during the polymerization, the feed being effected via both phases or in each case during one phase, and
viii) depleting the retarding compound during the first phase.

2. The process as claimed in claim 1, wherein from 10 to 30% by weight of the total mass of monomers to be polymerized is initially charged in step i).

3. The process as claimed in claim 1, wherein the total mass of emulsifier and/or protective colloid is initially charged in step i).

4. The process as claimed in claim 1, wherein the concentration of the vinyl ester monomer in the polymerization mixture over the duration of the first phase is ≧7.5% by weight and more preferably ≧9% by weight, and wherein the concentration of the vinyl ester monomer in the polymerization mixture at the end of the second phase is <5% by weight.

5. The process as claimed in claim 1, wherein the polymerization initiators used are thermally decomposing water-soluble and/or oil-soluble polymerization initiators, preferably a mixture of thermally decomposing water- and oil-soluble polymerization initiators.

6. The process as claimed in claim 1, wherein the compound which retards polymerization is selected from the group of the nitroaromatics, furans, vinylaromatics, allyl compounds, unsaturated dicarboxylic acids, and their anhydrides, salts, partial salts, full esters or partial esters with C₁-C₁₂-alkanols or the salts of these partial esters.

7. The process as claimed in claim 6, wherein the compound which retards polymerization is selected from the group of maleic acid, fumaric acid, of dibutyl maleate, monobutyl maleate, maleic anhydride, or the anhydrides or salts or partial salts thereof.

8. The process as claimed in claim 1, wherein the vinyl esters of a carboxylic acid used are vinyl esters of carboxylic acids having from 1 to 18 carbon atoms, especially vinyl esters of carboxylic acids having from 1 to 8 carbon atoms, vinyl esters of saturated, branched monocarboxylic acids having 9, 10 or 11 carbon atoms in the acyl radical, vinyl esters of relatively long-chain saturated and unsaturated fatty acids, and/or vinyl esters of benzoic acid or of p-tert-butylbenzoic acid.

9. The process as claimed in claim 8, wherein the vinyl ester of a carboxylic acid used is vinyl acetate.

10. The process as claimed in claim 1, wherein the further ethylenically unsaturated monomers polymerizable with the vinyl ester of a carboxylic acid used are monoethylenically unsaturated and optionally halogenated hydrocarbons having from 2 to 4 carbon atoms, preferably ethylene.

11. The process as claimed in claim 1, wherein the further ethylenically unsaturated monomers polymerizable with the vinyl ester of a carboxylic acid are anhydrides of ethylenically unsaturated carboxylic acids.

12. The process as claimed in claim 11, wherein the anhydride of ethylenically unsaturated carboxylic acids used is maleic anhydride.

13. The process as claimed in claim 9, wherein the first phase of the polymerization is performed at temperatures in the range from 56 to 66° C., preferably in the range from 59 to 66° C., especially in the range from 62 to 66° C., the temperature data being based on standard pressure.

14. The process as claimed in claim 9, wherein the second phase of the polymerization is performed at temperatures in the range from 50 to 95° C. and preferably in the range from 62 to 90° C., the temperature data being based on standard pressure.

15. The process as claimed in claim 1, wherein the feed of the further monomers is started within the first polymerization phase, or wherein the feed of the further monomers is started at the start of the second polymerization phase when the internal temperature rises.

16. The process as claimed in claim 15, wherein a lower feed rate is selected at the start of the feed of the further monomers and is then increased continuously and adjusted such that the monomer input is at its highest when the reaction rate reaches a maximum.

17. The process as claimed in claim 1, wherein the emulsifiers used are anionic and/or nonionic emulsifiers.

18. The process as claimed in claim 1, wherein the protective colloid used is polyvinyl alcohol.
